(19) United States
(12) Patent Application Publication
(10) Pub. No.: US 2024/0172775 A1
(43) Pub. Date: May 30, 2024

(54) CHITOSAN-BASED THERMOGELLABLE BINDING MIXTURES FOR VEGETABLE-BASED TEXTURED MEAT PRODUCTS

(71) Applicant: MYCOTECHNOLOGY, INC., Aurora, CO (US)

(72) Inventor: James Patrick LANGAN, Aurora, CO (US)

(73) Assignee: MYCOTECHNOLOGY, INC., Aurora, CO (US)

(21) Appl. No.: 18/553,383

(22) PCT Filed: Apr. 4, 2022
(86) PCT No.: PCT/US22/23314

§ 371 Date: Sep. 29, 2023

Related U.S. Application Data
(60) Provisional application No. 63/170,284, filed on Apr. 2, 2021.

(51) Int. Cl. A23J 3/22; A23J 3/14; A23L 29/275

(52) U.S. Cl. CPC A23J 3/227; A23J 3/14; A23L 29/275

(57) ABSTRACT

Disclosed herein is a process for making a thermogellable textured vegetable protein composition in the food forms of, for example, burgers, patties, balls, nuggets, sausages, and the like, which includes the steps of: providing a composition comprising a textured vegetable protein; providing a chitosan-based thermogellable binding mixture; and blending the plant-based meat analog ingredient and the chitosan-based thermogel mixture to form the thermogellable textured vegetable protein composition. In some aspects, the thermogellable binding mixture includes oil. The invention also includes compositions comprising a thermogellable textured vegetable protein composition, comprising a plant-based texturized protein, and a chitosan-based thermogellable binding mixture comprising chitosan, an acid source, an oil, and a base source.

### CROSS REFERENCE TO RELATED APPLICATIONS

This patent application claims the benefit of U.S. Provisional Patent Application No. 63/170,284, filed Apr. 2, 2021, which is incorporated by reference.

### BACKGROUND OF THE INVENTION

The hamburger (with ground meat patty) is a staple American food and a good-quality meat patty in a hamburger will have the taste and juiciness of grilled beef and a sufficiently solid texture so that the patty remains intact in the sandwich, yet is easy for the consumer to bite through, and the patty piece then easily disintegrates in the mouth after only a few mastications.

Forming a meat patty requires that the ground meat be sufficiently sticky to maintain its structure during and after being formed. When a meat hamburger patty is grilled, the fat melts and various soluble proteins are exuded from the cooking meat. These soluble proteins, which denature at temperatures above 140° F., bind the cooked ground meat particles together and trap the molten fat between the meat particles. Thus, the hamburger patty is able to provide the consumer with a unique eating experience. Its cooked structure is sufficiently integral to remain intact in the hamburger, bun, yet readily breaks apart in the mouth during mastication. Further, since the ground meat pieces are of variable size, they provide textural variety in the mouth when the hamburger piece is chewed, and the variable piece sizes also allow space for the molten fat to accumulate and supply juiciness to the eating experience.

Most plant-based food products attempt to mimic similar meat-based products, but this is difficult. Plant-based burgers generally are deficient in flavor, texture, and eating enjoyment. The majority of plant-based burgers use texturized vegetable protein to provide both protein and improved texture to the product. Although the texturized vegetable protein particles can overcome the “mushy” texture of purely vegetable-based burgers, they still suffer from significant eating quality defects relative to a meat hamburger. Namely, plant-derived pieces are not normally sticky like ground meat, so various formulations have been used to provide binding cohesiveness to the pieces so that a patty can be formed and maintain its integrity through the manufacturing and grilling steps. In general, plant-based patties are made by hydrating dried texturized vegetable protein pieces in a mixing vessel (water typically constitutes 50-60% of the final product) together with flavorings and oils. Additional materials are added to providing binding to the components, especially the texturized protein. In one embodiment, insoluble protein powders (such as gluten or isolated soy protein) and/or gums, starches, and sometimes egg white powders are added as binding agents.

Other types of meat alternative products in addition to burgers, includes patties, balls, nuggets, sausage links and may include a casing, coating, and/or breading; these also typically include binding agents.

A particularly useful gum or binding agent is methylcellulose, for example, Methocel™ A16m, which is a methylcellulose gum manufactured by The Dow Chemical Co., Midland, Mich.) Methylcellulose, however, is not a “natural” ingredient. It is the methyl ether of cellulose, produced by reacting methyl chloride and alkali cellulose. It contains 27.58%-31.5% of methoxy groups. Use of methyl cellulose in a food precludes the use of “natural” claims for the food.

There remains a need in the art for alternative thermogellable binding agents other than methylcellulose.

### SUMMARY OF THE INVENTION

In one aspect, the present invention includes a process for making a thermogellable textured vegetable protein composition (which can be in the finished food form of a burger, a patty, a ball, a nugget, a sausage, for example), comprising the steps of: providing a composition comprising a textured vegetable protein; providing a chitosan-based thermogellable binding mixture; and blending the plant-based meat analog ingredient and the chitosan-based thermogel mixture to form the thermogellable textured vegetable protein composition. In an aspect, the chitosan-based thermogellable binding mixture comprises chitosan, an acid source, an oil, and a base source.

In one embodiment, the chitosan-based thermogellable binding mixture can be made by a process comprising the steps of: blending chitosan, an acid source to form an mixture; and adding a base source to the mixture to form the chitosan-based thermogellable binding mixture. In one aspect, the oil is added before or during the step of blending the chitosan and the acid source. In another embodiment, the process of addition is stepwise.

In embodiments, the methods of the invention, can further comprise the step of cooking the thermogellable textured vegetable protein composition to form a thermogelled textured vegetable protein composition.

In embodiments of the invention, an acid useful for the present invention is vinegar and a base useful for the present invention is sodium bicarbonate. In embodiments of the invention, the acid source is a monoprotic acid and is provided at between about 10 mmol to about 100 mmol per g chitosan. In embodiments, the acid source is provided at about 40 mmol per g chitosan.

In embodiments, a base useful for the present invention can accept a single proton ion and is provided to the mixture at between about 20 mmol to about 120 mmol per g chitosan. In embodiments, the base is provided at about 60 mmol per g chitosan.

In embodiments, the oil is provided in a ratio to the chitosan of between about 0.5 g oil to 5 g oil to 1 g of chitosan; in one embodiment, the oil is provided at about 2 g oil to 1 g chitosan. The oil may include one or more of the following, soybean oil, corn oil, cottonseed oil, canola oil, sunflower oil, olive oil, sesame oil, avocado oil, grapeseed oil, coconut oil, and combinations thereof.

In embodiments, the ratio of chitosan-based thermogellable binding mixture to textured vegetable protein composition is about 1% to about 50% of the combined thermogellable textured vegetable protein composition by wet weight.

In certain embodiments of the present invention, the textured vegetable protein composition may further include flavoring ingredients and may also include a plant-based protein such as, for example, soy, pea, rice, hemp, cyanobacteria, myceliated protein, fermented protein, or combinations thereof.

In embodiments, the step of adding the base source to the emulsion to form the chitosan-based thermogellable binding mixture may include adding the base source until a pH of between about 6.3 and 6.6 pH units is reached in the mixture, or between about 6.4 to about 6.5 pH units.

The present invention includes a thermogellable textured vegetable protein composition made by disclosed methods, as well as thermogellable textured vegetable protein compositions, comprising a plant-based texturized protein, and a chitosan-based thermogellable binding mixture comprising chitosan, an acid source, an oil, and a base source. The compositions may be in the food form of, for example, a burger, patty, ball, nugget, or sausage.

### DETAILED DESCRIPTION

The present invention provides a method for the preparation and use of a chitosan-based thermogellable binding mixture, which is particularly useful for acting as a binding agent and as a thermogelling agent for foods, and in particular, for creating, for example, burgers, patties, balls, nuggets, sausage links (and may optionally, include a casing, coating, and/or breading compositions) using texturized vegetable protein. In particular, the present invention provides a chitosan-based thermogellable binding mixture can be used as a substitute for methylcellulose, as the present invention's functionality resembles methylcellulose's ability to bind and thermogel (e.g., provide a “setting” function upon the application of heat).

The invention's technical field is that of responsive thermogels for the food and beverage industry. Thermogels are materials that gel upon heating. More specifically, the present invention discloses novel formulations using chitosan to develop thermogels to produce formed food compositions comprising texturized vegetable protein. The chitosan-based thermogellable binding mixture may contain chitosan of either fungal or crustacean origin, and optionally has a degree of deacetylation between 50-100% and any number average molecular weight typical of chitosan (e.g. 1-1040 kDa). Accordingly the present invention is directed to chitosan-based thermogellable binding mixtures as an alternative to methylcellulose in thermogelling formulations and applications. The invention includes the use of thermogellable chitosan-based binding mixtures to bind and create thermogels using typical food industry products such as texturized vegetable protein finished food, for example, burgers, patties, balls, nuggets, sausage links (and may optionally, include a casing, coating, and/or breading compositions).

The term “binding” as used herein refers to promoting, supporting, or enabling holding together ingredients in one cohesive mass. The term “binding agent” as used herein refers to an agent that mediates binding. The term “emulsion” as used herein refers to a mixture of immiscible liquids in which one or more liquids (“dispersed phase(s)”) are dispersed as fine droplets in another liquid (“continuous phase”). The term “emulsifier” as used herein refers to a molecule that concentrates at the interface between the phases of an emulsion and reduces the interfacial tension between the phases and thus stabilizes the emulsion.

A “gel” or “gelling agent” refers to an agent that allows for a network of food particles that permeates the fluid in the food mixture, with the water immobilized. Such a network allows for a moist solid, or gel. Starch gelling agents include polysaccharides such as agar, which is a mixture of several different carbohydrates that is extracted from genera of red algae. Plant gums include gum arabic, guar gum, locust-bean gum, and bacterial carbohydrates such as xanthan gum and gellan. A particularly useful gum or binding agent is methylcellulose, for example, Methocel™ A16m, which is a methylcellulose gum manufactured by The Dow Chemical Co., Midland, Mich.) Methylcellulose is a particularly beneficial gum to use due to its unusual property of thermogelling behavior. Methyl cellulose's use as a thermogelling agent has been well established and it appears on the ingredient lists for many plant-based burger products, as well as other food products. It is the methyl ether of cellulose, produced by reacting methyl chloride and alkali cellulose. It contains 27.58%-31.5% of methoxy groups.

In one embodiment of the present invention, chitosan is used as the basis for a thermogellable binding mixture. Chitosan is a positively charged (at neutral pH) linear polysaccharide with a random arrangement of β-(1-4)-linked d-glucosamine and N-acetyl-d-glucosamine monomers. Chitosan is a derivative of chitin that results from the deacetylation of chitin, resulting in free amine functional groups on the polysaccharide's glucose monomers. The pKa of amine groups on the chitosan is around 6.6. However, the physiochemical properties of the chitosan can be varied based on the pH, molecular weights and the degree of deacetylation. The chitosan can be of either invertebrate, such as crustacean, or fungal origin; any chitosan is useful for the present invention where the chitosan has the function of providing binding and/or thermogelling ability according to the methods of the present invention. In one embodiment, the chitosan has a degree of deacetylation greater than 90%, although other grades of chitosan may be used as long as the chitosan has functionality as noted herein. Chitosan may be supplied in various molecular weight fractions. On average, the molecular weight of commercially produced chitosan is about 1000 to 60,000 daltons, or 30,000 to about 50,000 daltons, and such chitosan is useful for the present invention. In one embodiment, the chitosan is a fungal derived chitosan having a number average molecular weight of approximately 47.5 kDa. Chitosan is typically supplied in the form of a dried powder. In order to solubilize the dry powder, typically an acid (diluted, in water solution) can be used. Chitosan may be solubilized in acid by methods known in the art, such as, 9.3% (w/v) chitosan in 5% (w/v) acetic acid (e.g. vinegar).

In one embodiment, the present invention is based on a chitosan-based thermogellable binding mixture. This term “thermogellable binding mixture” refers to the fact that the mixture may be added to a food product at low temperatures (e.g. between room temperature and for example, 60° C.) which is not bound together and help bind it together to form a loosely bound, or formed food product, and then upon cooking (heating) create a thermosetting gel within the food to at least partially solidify the food for a formed cooked food product. A thermogellable binding mixture also provides an enhanced textural “chew” quality to the food which enhances the eating experience for consumers.

In one embodiment, chitosan is premixed with a dry acid (such as, for example, in the formation of a hydrochloride salt or mixed with a dry vinegar concentrate) and the mixture is added together to an aqueous solution such as water. In another embodiment, a dry acid is solubilized in an aqueous solution e.g. water to which chitosan is added and dissolved. In another embodiment, chitosan is added to a premixed acidic solution (e.g. vinegar) and dissolved.

In an embodiment, a food-grade acid is used (if not already present in the chitosan). Such food-grade acids include acetic acid, citric acid, hydrochloric acid, fumaric acid, lactic acid, phosphoric acid, malic acid, and tartaric acid. In some embodiments, the food grade acid can be any food grade vinegar (e.g. white vinegar, apple cider vinegar). Vinegar is commonly considered to be between 5 and 8% acetic acid. The acid is used to adjust the pH of the chitosan/acid mixture to about 2-3 pH units or lower in order to solubilize or emulsify the chitosan. Upon solubilization of the chitosan, the acid/chitosan mixture may have a pH in the about pH 4-5 unit range.

To prepare the chitosan-based thermogellable binding mixture, powdered chitosan, water, and the acid are mixed to dissolve the chitosan. In one embodiment, acid (e.g., such as vinegar) is first added to a vessel and agitated, followed by slow addition of chitosan. The dissolution may take 1-2 hours. Agglomerated and/or undissolved chitosan may be mechanically separated if desired. Decreasing the temperature decreases solubilization time (i.e. chitosan dissolves faster at lower temperature, especially as the process proceeds). Depending on the chitosan concentration, one may dilute the acid with water (e.g. RO water) and still fully dissolve a certain mass of chitosan, although at greater concentrations of chitosan, ˜5% (w/v) pure vinegar may be used to facilitate dissolution. Other food grade acids may be used to develop homogenous chitosan solutions. In some embodiments, a molar ratio of about 40 mmol of hydronium ion (acid) is required to solubilize approximately 1 g of chitosan.

In embodiments, the dissolved chitosan is further mixed with a food grade oil (or fat). This step is optional. The food grade oil provides for improved handling of the resultant chitosan-based thermogellable binding mixture, as the mixture is “softer” and more pliable to handle, and also can provide a source of oil into the food product into which the chitosan-based thermogellable binding mixture is used. Once the chitosan has been homogenously dissolved, the food grade oil may be added and mixed into the solution to develop an emulsion. The food grade oil may be any food grade oil, and may be selected based on the application for which the chitosan-based thermogellable mix is used. For example, vegetable oils such as canola, cottonseed, corn, sunflower, olive, and the like, may be used. For confectionary applications, oils such as palm oil, coconut oils, cacao butter may be used. Other oils include avocado, peanut, sesame, and other nut oils. Optionally, other emulsifying agents, such as lecithin, may be used. The amount of oil to add is flexible and the amount to add to the chitosan-based thermogellable binding mixture may be “tuned” by the properties desired in the eventual food product.

The solubilized chitosan with optional oil may then be “activated” in order to create the thermogellable mixture. Typically, a base is added to raise the pH back to a pH that is just greater than the pKa of the chitosan but less than the equivalence point. This differentiates from previous teachings, which recommend raising the pH to 7. Without being bound by theory, the art teaches that a pH this high causes the chitosan to precipitate and most of the water to separate. Such a “broken” emulsion or mixture has significant less utility as a binder. Although such a broken chitosan emulsion may still thermogel, its ability to bind materials together is significantly reduced.

A food-grade base, such as, for example, sodium bicarbonate may be added to the developed emulsion to enable thermogellation. Thermogellation is enabled when the pH of the mixture is brought closer to the pKa of chitosan. Adding base will deprotonate the amine functional groups bringing the chitosan to have no net charge and promote the hydrophobic interactions between chitosan molecules when the material is heated. Typical final pH for the mixture is between about 6.2 and about 6.8, or between about 6.4 and 6.6, or about 6.45 to about 6.55. Put another way, the amount of base to use to bring the mixture to the correct pH is, in one embodiment, about 1 g chitosan (in some embodiments, also equivalent to approximately 0.02 mmol chitosan, based on a fungal derived chitosan having a number average molecular weight of 47.5 kDa), 40 mmol acid, and 60 mmol base (on a molar basis), with an optional oil amount of about 2 g oil. Any food grade base may be used, such as baking soda (sodium bicarbonate), sodium hydroxide, potash (potassium hydroxide), beta glycerol phosphate, alanine, among any other food grade base that has similar functional properties.

There is a wide range of ratios at which the various components of the formulation can be mixed to produce an appropriate thermogellable mixture. Chitosan may comprise ˜1-80% of the material (dry weight chitosan to weight of the mixture), oil may comprise 0-900% of the material, and the acid and base mixture may be any amount that results in the production with functional properties of the thermogel as described herein. These values may be adjusted to affect various aspects of the final mixture such as rheology, stability and thermogellation properties.

Although the chitosan-based thermogellable binding mixture is typically mixed into foods before the thermogellation step, the chitosan-based thermogellable binding mixture itself may be thermogelled by heating. The thermogel will form at temperatures similar to analogous methyl cellulose formulations (71-74° C.). The gel remains strong even upon cooling, although may lose some of its strength.

The activated emulsion (e.g., the chitosan-based thermogellable binding mixture) may be added to compositions comprising solids or liquids, and the compositions can then be cooked to take advantage of the chitosan-based thermogellable binding mixtures' binding and/or thermogelling properties. For example, the chitosan-based thermogellable binding mixture may be used in baked goods, desserts, fried foods, and soups. The present invention can be used in any foodstuff where a thermogelling agent is used to provide structural integrity to the shape of the material before and after (i.e. the material binds the material together before heating and provides texture when heated to a thermogel) application of heat (e.g. cooking) and when the textural properties of thermogels are desired in the sensory properties of the prepared foodstuff.

In the present invention, the chitosan-based thermogellable binding mixture is particularly suitable to create food forms and compositions that include texturized vegetable protein, although as noted the thermogellable binding mixture is useful in many different types of matrices. In particular, the instant invention can be used as a binder and/or thermogellable agent to make a texturized vegetable protein-based finished “meat” type of composition, for example, burgers, patties, balls, nuggets, sausage links (and may optionally, include a casing, coating, and/or breading compositions). In general, texturized vegetable-protein based alternative meats in the form of, for example, burgers, patties, balls, nuggets, and sausage links, are made by using texturized vegetable protein pieces in a mixing vessel together with optionally, water, oil, flavorings, color, and, to provide binding to the pieces, the chitosan-based thermogellable binding mixture may be added. The entire mass is mixed for a defined period.

Any composition comprising a texturized vegetable protein is suitable for use with the present invention. Such texturized vegetable proteins include textured vegetable protein concentrates or isolates from such vegetable and grain sources such as soy, pea, rice, hemp, cyanobacteria, grain, chia, chickpea, potato, algal and nettle; as well as mixtures thereof. Texturized myceliated high-protein food products may also be used in the present invention. See, e.g., U.S. Patent publication no. US 2020/0060310, Ser. No. 16/666,936, filed Oct. 29, 2019; U.S. Pat. No. 10,010,103, filed Apr. 14, 2017, U.S. Ser. No. 16/025,365, (filed Jul. 2, 2018), related to aqueous-phase fermentation of protein materials, and texturizing same, including that of a pea and rice protein fermented by shiitake mycelia, all of which are incorporated by reference herein in their entireties. Texturizing refers to use of extruders as known in the art to heat or extrude vegetable protein concentrates or isolates into various shapes (chunks, flakes, nuggets, grains, and strips) and sizes, where the extruded mixture exits the nozzle while still hot and expands as it does so. The thermoplastic proteins in the vegetable protein are heated to 150-200° ° C., which denatures them into a fibrous, insoluble, porous network that can soak up as much as three times its weight in liquids. As the pressurized molten protein mixture exits the extruder, the sudden drop in pressure causes rapid expansion into a puffy solid that is then dried. As much as 50% or more protein when dry, textured plant protein can be rehydrated at a 2:1 ratio, for example.

A textured vegetable protein composition may include a number of ingredients, such as water, fiber, protein powder, texturized protein, binders, oil, seasonings and flavors, in order to form the food product. In one embodiment, a plant-based burger as known in the art may contain, for example, a plant-based texturized protein 18.42% (dry weight), a plant-based protein powder 6.01% dry weight, vital wheat gluten 7.62%, methylcellulose 2.00%, beef flavor 2.20%, grill flavor, 2.61%, chicken flavor 1.80%, beet powder 0.70%, unrefined coconut oil 2.00%, brown flavor 0.1%, water 56.11%. The chitosan-based thermogellable binding mixture may be used to replace one or more of the vital wheat gluten, and methylcellulose.

Thus, in one embodiment, the present invention includes a process for making a thermogellable textured vegetable protein product; for example, burgers, patties, balls, nuggets, sausage links, etc. comprising texturized vegetable protein. This method includes providing a composition comprising a hydrated texturized vegetable protein including other optional ingredients; providing a chitosan-based thermogellable binding mixture; and blending the plant-based meat texturized protein composition and the chitosan-based thermogellable binding mixture to form the thermogellable textured vegetable protein composition. In one embodiment, a “burger” using the chitosan-based thermogellable binding mixture may include from about 5% (by weight) of the chitosan-based thermogellable binding mixture (wet weight) to about 70% or more by weight of the total burger components. In some embodiments, the amount of chitosan-based thermogellable binding mixture is from about 10% to about 60%, from about 20% to about 40%, or about 25 to 35%, (by weight) of the chitosan-based thermogellable binding mixture (wet weight) to by weight of total burger (wet weight).

In specific embodiments, the chitosan-based thermogellable binding mixture comprises chitosan, an acid source, an oil, and a base source. In some embodiments, the acid source is vinegar. In some embodiments, the base source is sodium bicarbonate. The chitosan-based thermogellable binding mixture may be made by a process comprising the steps of blending chitosan, an acid source, to solubilize the chitosan; adding an oil to form an emulsion with the chitosan and acid source, and adding a base source to the emulsion to form the chitosan-based thermogellable binding mixture. The process may be stepwise.

In one embodiment, the acid source is provided in a relative amount to the chitosan of between about 1 mmol of acid to about 100 mmol acid, per gram chitosan; between about 5 mmol of acid to about 90 mmol acid, per gram chitosan; between about 10 mmol of acid to about 80 mmol acid, per gram chitosan; between about 15 mmol of acid to about 70 mmol acid, per gram chitosan; between about 20 mmol of acid to about 65 mmol acid, per gram chitosan; between about 25 mmol of acid to about 60 mmol acid, per gram chitosan; between about 30 mmol of acid to about 55 mmol acid, per gram chitosan; between about 35 mmol of acid to about 50 mmol acid, per gram chitosan; or between about 30 mmol of acid to about 45 mmol acid, per gram chitosan; all acid amounts for monoprotic acids.

In one embodiment, the base is provided in a relative amount to the chitosan of between about 10 mmol of base to about 120 mmol base, per gram chitosan; between about 15 mmol of base to about 110 mmol base, per gram chitosan; between about 20 mmol of base to about 100 mmol base, per gram chitosan; between about 25 mmol of base to about 90 mmol base, per gram chitosan; between about 30 mmol of base to about 85 mmol base, per gram chitosan; between about 35 mmol of base to about 80 mmol base, per gram chitosan; between about 40 mmol of base to about 75 mmol base, per gram chitosan; between about 45 mmol of base to about 70 mmol base, per gram chitosan; between about 50 mmol of base to about 65 mmol base, per gram chitosan; or between about 55 mmol of base to about 60 mmol base, per gram chitosan; all base amounts for monobasic salt.

The oil may be provided in a wide range of ratios and can be “tuned” in accordance with the desired properties of the resultant food product. Generally, the oil is provided in a ratio to the chitosan of about between about 0.1 g oil to about 20 g oil, per gram chitosan; between about 0.4 g oil to about 15 g oil, per gram chitosan; between about 0.8 g oil to about 10 g oil, per gram chitosan; between about 1.2 g oil to about 5 g oil, per gram chitosan; between about 1.6 g oil to about 4 g oil, per gram chitosan; or between about 1.8 g oil to about 3 g oil, per gram chitosan.

In other methods to express the ratios of the thermogellable composition, in an exemplary embodiment, the chitosan is provided as 7 g in a composition; vinegar is provided in an amount of 37 mL in the composition; olive oil is provided in an amount of 15 ml, baking soda is provided in amount of 4 g; and water is provided in an amount of 37 ml. From this weight of 100 g, 7% is chitosan and 15% is olive oil.

In specific embodiments, the ratio of chitosan-based thermogellable binding mixture to textured vegetable protein composition (entire mixture) is between about 1% and 50% by weight, between about 10% and 40% by weight, between about 20 and 30% by weight.

To activate the chitosan-based thermogellable binding mixture, the method further comprises the step of cooking the thermogellable textured vegetable protein composition to form a thermogelled textured vegetable protein composition, by methods known in the art, such as frying, baking, and the like. In one specific embodiment, the step of cooking involves heating the thermogellable textured vegetable protein composition to a temperature of about 70° C. (158º F) to about 90.6° C. (195º F) for the thermogel to form.

In embodiments, thermogelled textured vegetable protein compositions of the invention have certain textural properties that are similar to those textured vegetable compositions that use methylcellulose as the binder. For example, textural properties such as springiness, hardness, fracturability, density, and crispness (which can be measured by those of skill in the art and are routinely known to those in the art) are similar to, and in some embodiments, improved over textured vegetable protein compositions using methylcellulose as a binder. For example, springiness and hardness were improved and more comparable to animal protein products for the compositions of the invention as compared to similar compositions using methylcellulose as a binder and not the thermogellable binding mixture of the invention.

The present invention includes thermogellable textured vegetable protein composition (either cooked or uncooked) made by methods disclosed herein. The present invention also includes a thermogellable textured vegetable protein composition, comprising a texturized vegetable protein, and a chitosan-based thermogellable binding mixture comprising chitosan, an acid source, optionally an oil, and a base source. In an embodiment, the ratio of chitosan-based thermogellable binding mixture to texturized vegetable protein composition is about 1% to about 50% of the texturized vegetable protein composition.

### EXAMPLES

### Example 1—Thermogellable Solutions with Canola Oil

2 g of chitosan (95% DDA, number average molecular weight of approximately 47.5 kDa by vendor specifications) extracted from Pleurotus ostreatus fruitbody was placed into a clean, 0.95 L ¼ gal Ziplock bag. 10 mL of a white vinegar (0.833 mmol/ml acetic acid, resulting in 8.3 mmols acid (0.008 mol)), 4 mL canola oil (canola oil: 0.9 g/ml at RT, total of 3.6 mg) and 23 mL RO water were added to a 50 mL graduated cylinder and poured into the Ziploc bag. The bag was sealed, with as much air being forced out as possible, and was kneaded for ˜5 min until a soft, nonflowing emulsion was formed. 1 g of baking soda (sodium bicarbonate, NaHCO₃, 84 g/mol, or 0.012 mol) was added to the Ziploc bag and the bag was kneaded similarly to when the emulsion was developed. The ratios are as follows: per gram of chitosan, ratios are as follows: 1.8 g canola oil, 0.004 mol acetic acid, 0.006 mole bicarb, in a total volume of 37 mL aqueous solution. 2 g of this activated emulsion was placed into a 100 mL Pyrex beaker placed on a hot plate set to 200° C. In a matter of five minutes the soft material of the activated emulsion turned into a hard thermogel. Compared to a thermogel utilizing methyl cellulose formulated similarly but for the lack of vinegar and baking soda, the thermogel that formed with this chitosan formulation was similar in resistance to deformation and felt essentially as an identical material. Furthermore, both chitosan and methyl cellulose formulations seem to thermogel responsively to temperature at essentially the same rate.

### Example 2—Thermogellable Solutions with Olive Oil

2 g of chitosan (95% DDA, number average molecular weight of approximately 47.5 kDa by vendor specifications) extracted from Pleurotus ostreatus fruitbody provided by a 3rd party was placed into a clean, 0.95 L (¼ gal) Ziplock bag. 10 mL (0.833 mmol/ml acetic acid, resulting in 8.3 mmols acid (0.008 mol)), of a white vinegar, 4 mL extra virgin olive oil (olive oil: 0.917 g/mL at RT, resulting in 3.7 g olive oil) and 23 mL RO water were added to a 50 mL graduated cylinder and poured into the Ziploc bag. The bag was sealed, with as much air being forced out as possible, and was kneaded for ˜5 min until a soft, nonflowing emulsion was formed. 1 g of baking soda (sodium bicarbonate, NaHCO₃, or 0.012 mol) was added to the Ziploc bag and the bag was kneaded similarly to when the emulsion was developed. 2 g of this activated emulsion was placed into a 100 mL Pyrex beaker placed on a hot plate set to 200° C. A thermogel eventually formed according to other descriptions of the invention. The ratios are as follows: per gram of chitosan, ratios are as follows: 1.83 mg olive oil, 0.008 mol acetic acid, 0.006 mole bicarb, to a total volume of 18.5 mL aqueous solution.

### Example 3—Reduced Ratio of Acid Thermogellable Solutions

2.4 g of chitosan (95% DDA, number average molecular weight of approximately 47.5 kDa by vendor specifications) extracted from Pleurotus ostreatus fruitbody provided by a 3rd party was placed into a clean, 0.95 L-¼ gal-Ziplock bag. 4 mL of a white vinegar (0.833 mmol/ml acetic acid, resulting in 3.36 mmols acid (0.004 mol)), 5 mL canola oil (canola oil: 0.9 g/mL at RT, total of 3.6 g) and 26.6 mL RO water were added to a 50 mL graduated cylinder and poured into the Ziploc bag. The bag was sealed, with as much air being forced out as possible, and was kneaded for ˜5 min until a soft, nonflowing emulsion was formed. 1 g of baking soda (sodium bicarbonate, NaHCO₃, or 0.012 mol) was added to the Ziploc bag and the bag was kneaded similarly to when the emulsion was developed. The ratios are as follows: per gram of chitosan, ratios are as follows: 1.5 mg canola oil, 1.7 mmol acetic acid, 0.006 mol bicarb, in a total volume of 17.8 mL aqueous solution. 2 g of this activated emulsion was placed into a 100 mL Pyrex beaker placed on a hot plate set to 200° C. A thermogel eventually formed according to other descriptions of the invention but thermosetting was delayed.

### Example 4—Concentrated Thermogellable Solutions

87 mL of a distilled white vinegar (0.833 mmol/ml acetic acid, resulting in 72 mmol acid (0.072 mol)) was added to a clean beaker and agitated to 900 RPM with a magnetic stir bar. 7 g of chitosan from crustacean origin (standardized to >90% deacetylation, unknown molecular weight) was slowly added to the agitating vinegar, eventually increasing the RPM to a maximum 1,500. The chitosan was intermittently agitated to ensure homogenization and over the course of 2 hours homogenously dissolved in the vinegar. At this point, 1 mL of canola oil (canola oil: 0.9 g/mL at RT, total of 0.9 g) was added to the solution and stirred until homogeneity. Then, 5 g of baking soda (sodium bicarbonate, NaHCO₃, or 0.06 mol) was added and stirred until homogeneity. The ratios are as follows: per gram of chitosan, ratios are as follows: 1.8 g canola oil, 0.004 mol acetic acid, 0.006 mole bicarb, in a total volume of 1 mL aqueous solution. The amount of chitosan As the material was being mixed with the sodium bicarbonate, the material would rise due to carbon dioxide generation. The material was mechanically agitated with a clean, stainless steel tool to break apart the material and release the carbon dioxide. Once the material stopped rising, it was intermittently mixed and left to sit for ˜30 minutes. ˜ 1 g of the activated emulsion was placed into a Pyrex beaker that was placed on a hot plate set to 200° C. After ˜5 minutes, the material had thermogelled at ˜72° C. and displayed good yield strength similar to analogous methyl cellulose thermogels.

### Example 5

7 g of chitosan (95% DDA, 95% DDA, number average molecular weight of approximately 47.5 kDa by vendor specifications) extracted from Pleurotus ostreatus fruitbody was placed into a clean Ziplock bag. 37 mL of a white vinegar (0.833 mmol/ml acetic acid, resulting in 30.8 mmols acid (0.031 mol)), 15 mL olive oil (olive oil: 0.917 g/mL at RT, total of 13.8 g) and 37 mL RO water were poured into the Ziploc bag. The bag was sealed, with as much air being forced out as possible, and was kneaded for ˜5 min until a soft, nonflowing emulsion was formed. 4 g of baking soda (sodium bicarbonate, NaHCO₃, 84 g/mol, or 0.047 mol) was added to the Ziploc bag and the bag was kneaded similarly to when the emulsion was developed. Total weight is 100 g. The ratios are as follows: per gram of chitosan, there is 2 g olive oil, 0.004 mol acetic acid, 0.006 mole sodium bicarbonate, in a total volume of 89 mL aqueous solution or 100 g. To express by weight, the material is 7% w/w chitosan (approximately 0.000014 mol), 37% vinegar (0.004 mol), 15% olive oil, and 4% sodium bicarbonate (0.006 mol). 2 g of this activated emulsion was placed into a 100 mL Pyrex beaker placed on a hot plate set to 200° ° C. In a matter of five minutes the soft material of the activated emulsion turned into a hard thermogel. Compared to a thermogel utilizing methyl cellulose formulated similarly but for the lack of vinegar and baking soda, the thermogel that formed with this chitosan formulation was similar in resistance to deformation and felt essentially as an identical material. Furthermore, both chitosan and methyl cellulose formulations seem to thermogel responsively to temperature at essentially the same rate

### Example 6

In preparing a vegan imitation ‘burger’, 210 g of texturized protein was first hydrated with 385 mL RO water for ˜11 minutes in a kitchen mixer. Twenty (20) g of shiitake fermented pea and rice protein (made by methods disclosed in U.S. Pat. No. 10,010,103, which are incorporated herein by reference in its entirety), was then added as well as 25 g standard “burger seasoning”, 10 g of a yeast extract imitation ‘beef flavor’, 6 g of a yeast extract imitation ‘chicken flavor’ and 6 g of beet powder and mixed for ˜5 minutes. This material was then further mixed with 145 mL of canola oil, and 323 g of chitosan based activated emulsion prepared according to Example 5 was added and finally mixed to produce the vegan ‘raw meat’ for ˜5 minutes. This ‘raw meat’ was formed into patties and frozen at −20° C. 24 hours later, the material was thawed for ˜3 hours and cooked on a frying pan in canola oil at medium heat. The ‘burger’ changed color through cooking, was cooked on both sides and internally reached ˜72° C. for 5 minutes before being taken off the stove. The ‘burger’ behaved similarly to analogous ‘burgers’ formulated with methyl cellulose. The ‘burger’ described herein had cooked through the center and provided a delicious, umami taste with no off-notes and good texture desirable of such products, as was determined by various food scientists and the present inventors.

### Example 7

In preparing a vegan imitation ‘burger’, 97 g of texturized protein was first hydrated with 177 mL RO water for ˜11 minutes in a kitchen mixer. Nine (9) g of shiitake fermented pea and rice protein was then added as well as 11 g burger seasoning, 15 g of a yeast extract imitation ‘beef flavor’, 2.75 g of a yeast extract imitation ‘chicken flavor’ and 2.75 g of beet powder and mixed for ˜5 minutes. This material was then further mixed with 67 mL of canola oil and 150 g of chitosan based activated emulsion. The chitosan based activated emulsion was prepared by dissolving 8 g of chitosan from fungal origin (identical to the chitosan used in Example 1) in 85.8 mL of distilled white vinegar (standardized to 5% acetic acid) (0.833 mmol/mL acetic acid, resulting in 30.8 mmol acid (0.071 mol)) at 4° C. The vinegar had a pH of ˜2.5 and the pH increased to ˜4.6 upon dissolution of the chitosan. At this point 1 mL of canola oil was added to the chitosan solution and mixed in, whereupon 5.2 g of baking soda (sodium bicarbonate, NaHCO₃, 84 g/mol, or 0.011 mol) was added and thoroughly mixed. The chitosan based activated emulsion sat for 2 hours at room temperature before being mixed into the textured vegetable protein burger composition and was recorded to have a pH of ˜6.53 before being mixed. Once all components were thoroughly mixed, the resulting ‘raw’ vegan ‘meat’ was formed into a patty shape and frozen at −20° C. overnight. The next day the burgers were thawed and cooked on a low medium heat until an internal heat of 71° C. was reached. This required flipping the ‘burger’ every 3 minutes approximately 4 times. The burger was cooked on a gas stove in a cast iron pan that had food grade oil sprayed on before applying the burger. Once the burger was cooked and cooled slightly, multiple people tasted the burger. Every taster enjoyed the burger, commenting that it had good, meat-like texture and a good, savory flavor.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. The term “consisting of” is construed as a close-ended term (i.e., excluding components or steps other than those listed). The term “consisting essentially of” allows for the inclusion of components or steps that are not essential to the function or activity of the product or method and do not materially affect the function or activity.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1.-38. (canceled)

39. A process for making a thermogellable textured vegetable protein composition comprising the steps of:
a) providing a composition comprising a textured vegetable protein;
b) providing a chitosan-based thermogellable binding mixture; and
c) blending the plant-based meat analog ingredient and the chitosan-based thermogel mixture to form the thermogellable textured vegetable protein composition.

40. The method of claim 39, wherein the chitosan-based thermogellable binding mixture comprises chitosan, an acid source, an oil, and a base source.

41. The method of claim 39, wherein the chitosan-based thermogellable binding mixture is made by a process comprising the steps of:
a) blending chitosan, an acid source to form a mixture; and
b) adding a base source to the mixture to form the chitosan-based thermogellable binding mixture.

42. The method of claim 41, wherein the chitosan-based thermogellable binding mixture further comprises an edible oil.

43. The method of claim 42, wherein the edible oil is added before or during the step of blending the chitosan and the acid source.

44. The method of claim 41, wherein the acid source is vinegar and the base source is sodium bicarbonate.

45. The method of claim 41, wherein the acid source is a monoprotic acid and is provided at between about 10 mmol to about 100 mmol per gram of chitosan.

46. The method of claim 41, wherein the base source can accept a single proton and is provided at between about 20 mmol to about 120 mmol per gram of chitosan.

47. The method of claim 41, wherein the oil is provided in a ratio to the chitosan of between about 0.5 g oil to 5 g oil to 1 g of chitosan.

48. The method of claim 47, wherein the ratio is about 2 grams of oil to 1 gram of chitosan.

49. The method of claim 41, wherein the step of adding the base source to the emulsion to form the chitosan-based thermogellable binding mixture comprises adding the base source until a pH of between about 6.3 and 6.6 pH units is reached in the mixture.

50. The method of claim 41, wherein the oil is selected from the group consisting of soybean oil, corn oil, cottonseed oil, canola oil, sunflower oil, olive oil, sesame oil, avocado oil, grapeseed oil, coconut oil, and combinations thereof.

51. The method of claim 39, wherein a ratio of chitosan-based thermogellable binding mixture to textured vegetable protein composition is about 1% to about 50% of the combined thermogellable textured vegetable protein composition by wet weight.

52. The method of claim 39, wherein the plant-based texturized protein comprises a plant-based protein comprising soy, pea, rice, hemp, cyanobacteria, myceliated protein, or combinations thereof.

53. The method of claim 52, wherein the plant-based texturized protein comprises a myceliated protein.

54. A thermogellable textured vegetable protein composition made by the method of claim 39.

55. A composition comprising a thermogellable textured vegetable protein composition, comprising a plant-based texturized protein, and a chitosan-based thermogellable binding mixture comprising chitosan, an acid source, an oil, and a base source.

56. The composition of claim 55, wherein the acid source is vinegar and the base source is sodium bicarbonate.

57. The composition of claim 55, wherein the acid source is provided at between about 10 mmol to about 100 mmol per g chitosan, and the base source is provided in a ratio at between about 20 mmol to about 120 mmol per g chitosan.

58. The composition of claim 55, wherein the oil is provided in a ratio to the chitosan of between about 0.5 grams of oil to 5 grams of oil to 1 gram of chitosan.

59. The composition of claim 55, wherein the oil is selected from the group consisting of soybean oil, corn oil, cottonseed oil, olive oil, canola oil, sunflower oil, sesame oil, grapeseed oil, coconut oil, and combinations thereof.

60. The composition of claim 55, wherein the ratio of chitosan-based thermogellable binding mixture to textured vegetable protein composition is about 1% to about 50% of the combined thermogellable textured vegetable protein composition.

61. The composition of claim 55, wherein the plant-based texturized protein comprises a plant-based protein comprising soy, pea, rice, hemp, cyanobacteria, myceliated protein, or combinations thereof.

62. The composition of claim 55, wherein the plant-based texturized protein comprises a myceliated protein.

63. The composition of claim 55, wherein the chitosan-based thermogellable binding mixture before addition to the mixture has a pH of between about 6.3 and 6.6 pH units.
